(19) United States
(12) Patent Application Publication
(10) Pub. No.: US 2020/0074084 A1
(43) Pub. Date: Mar. 5, 2020

(54) PRIVACY-PRESERVING COMPONENT VULNERABILITY DETECTION AND HANDLING

(71) Applicant: Microsoft Technology Licensing, LLC, Redmond, WA (US)

(72) Inventors: Barry DORRANS, Seattle, WA (US); Levi Patrick BRODERICK, Redmond, WA (US)

(21) Appl. No.: 16/115,606

(22) Filed: Aug. 29, 2018

(51) Int. Cl. G06F 21/57; G06F 21/62; G06F 8/77

(52) U.S. Cl. CPC G06F 21/577; G06F 2221/034; G06F 8/77; G06F 21/6245

(57) ABSTRACT

Tools and techniques are described to protect private configuration and operation information while obtaining pertinent data about known vulnerabilities of packages, runtimes, and software components of various kinds. Dependencies between software items may be traversed to get more complete vulnerability information. Version numbers and other telemetry about installed components, and operational events from installed components, may be exported from a system while nonetheless protecting the privacy of system-specific details. Privacy protections may include withholding private information from a repository or other vulnerability list source, using truncated hashes or fingerprints to select an obscuring subset of the available vulnerability list, anonymizing telemetry, aggregating telemetry, and other mechanisms. Vulnerability warnings may be given upon loading a component or launching an application, building a project, selecting a component for deployment, adding a component to a project or workspace, and other events. Updates to components may be performed to remove known vulnerabilities.

### BACKGROUND

Responses to identified security risks may be categorized as mitigation, acceptance, avoidance, or transference. Mitigation attempts to reduce a risk to an acceptable level. Acceptance recognizes a risk as acceptable in view of potential benefits associated with the risky situation. Avoidance removes the risk associated with an activity by avoiding the activity. Transference transfers risk liability, e.g., to an insurance provider. As to mitigation in particular, efforts to reduce risk are known as “controls” and may be categorized as physical, technical (sometimes called “logical”), or administrative controls. Some familiar physical controls include fences, door locks, and fire suppression systems. Some familiar technical controls include computing system firewalls, anti-virus software, and encryption. Some familiar administrative controls include separation of duties, job rotation, and acceptable use policies. Multiple security controls, in the same or different categories, may be used together to provide defense-in-depth.

Cybersecurity may be viewed as a subset of security. Cybersecurity tries to reduce or prevent attacks that damage desirable qualities of digital data or computing resources, such as confidentiality, availability, integrity, and privacy. Cyberattacks take many forms, including social engineering efforts such as phishing, compute-intensive attacks such as brute force attacks on passwords, open attacks such as adware and ransomware, hidden attacks such as rootkits and data leaks, attacks focused on particular resources such as computing power (creating a zombie army of bots) or storage (hijacking web server storage to hold illegal materials), attacks that target specific kinds of data (e.g., medical histories, credit card data), and many other forms of attack.

### SUMMARY

Some teachings herein were motivated by an initial technical challenge of updating installed components when information is spotty at best about which components are installed in which versions on which systems. A subordinate challenge was how to obtain telemetry from installed components. An emergent technical challenge was how to notify a component utilizer when components it may utilize have security vulnerabilities, without requiring the component utilizer to disclose private system configuration information. Other technical challenges addressed by the innovations taught here will also be apparent to one of skill from the discussion provided below.

Some vulnerability notification embodiments include a processor, a memory in operable communication with the processor, a component utilizer, and a vulnerability detection and notification provider. The vulnerability detection and notification provider is configured to obtain a vulnerable components list which includes a list of vulnerable component descriptions. The embodiment compares at least a portion of the vulnerable components list to a list of utilizable components, namely, components that are installed on the computing system or otherwise available to the component utilizer. Then the embodiment generates a vulnerability notification to notify a user that at least one utilizable component is has a known vulnerability. The vulnerable components list may be obtained without disclosing any utilizable component descriptions, which may be indicated by the presence of items on the vulnerable components that do not appear on the utilizable components list.

Some private proactive vulnerability detection and notification embodiments provide or use particular actions. For example, an embodiment may obtain, from a vulnerable components list source, a vulnerable components list which includes multiple vulnerable component descriptions. The embodiment may also get a utilizable components list, which includes multiple utilizable component descriptions. The vulnerabilities list may be obtained without supplying to its source any information which specifically identifies any of the listed utilizable components. That is, the embodiment may withhold from the vulnerable components list source any identification of the computing system's installed components. The embodiment may then compare the lists, thereby ascertaining one or more utilizable vulnerable components, which are on both lists, and then generate a vulnerability notification that names at least one such utilizable vulnerable component.

Other technical activities pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system and also illustrating a configured storage medium;

FIG. 2 is a block diagram illustrating aspects of a computing technology environment which includes a component utilizing system, a vulnerabilities base system, and other items;

FIG. 3 is a block diagram illustrating aspects of a vulnerable component description;

FIG. 4 is a block diagram illustrating aspects of a utilizable component description;

FIG. 5 is a block diagram illustrating aspects of a vulnerabilities list request;

FIG. 6 is a block diagram illustrating examples of a component utilizer;

FIG. 7 is a block diagram illustrating examples of an operating environment;

FIG. 8 is a block diagram illustrating examples of logging functionalities;

FIG. 9 is a block diagram illustrating examples of metadata of a utilizable component;

FIG. 10 is a flowchart illustrating steps in some vulnerability detection and notification methods;

FIG. 11 is a block diagram further illustrating some contexts in which components are utilized; and

FIG. 12 is a flowchart further illustrating steps in some vulnerability detection and notification methods.

### DETAILED DESCRIPTION

Overview

Innovations may expand beyond their origins, but understanding an innovation's origins can help one more fully appreciate the innovation even when the innovation has grown well beyond its original focus. In the present case, private vulnerability notification innovations arose in the context of the inventors seeking ways to improve software component functionalities using telemetry from installed components. Specifically, the inventors lacked visibility into component use on Azure® cloud virtual machines (mark of Microsoft Corporation). Some customers disliked providing telemetry which would give visibility into component usage and operation, due to privacy concerns.

However, limiting telemetry can have unintended side-effects. Some customers using some infrastructure products, such as .NET Core™ software (mark of Microsoft Corporation), were not aware when new patches for their software became available, and did not know whether their software was current with the available patches. Without knowing which components were installed on which systems, vendors have no clear way to determine who to contact when an update becomes available, even if one takes the view that such contacts should be initiated by vendors. From this situation, the inventors sought improvements in tools and techniques for security notifications and uptimes in a runtime system that would be welcomed by vendors and customers alike.

Some approaches to software updating for developer frameworks have relied on external services like the Microsoft Update™ service. Such approaches may rely on a user taking initiative by actively running the external service. Some embodiments presented herein move checks for superseded code into a runtime itself, thereby providing an always-on updating mechanism. Some embodiments check more than the runtime, e.g., by checking dependencies that the runtime loads. In this context .NET Core™ is a runtime, and ASP.NET Core™ is a framework (marks of Microsoft Corporation). Some embodiments also provide a cross-platform mechanism for delivering security notifications to, e.g., MacOS® platforms (mark of Apple, Inc.), Linux® platforms (mark of Linus Torvalds), Windows® platforms (mark of Microsoft Corporation), Android® platforms (mark of Google, LLC), and other platforms.

Some embodiments place checks for dependencies and runtime components which have security vulnerabilities within the runtime itself, rather than rely upon external mechanisms to scan configuration data and notify a system administrator if a lack of patching or other vulnerabilities are found. Updates to the vulnerability information can be provided by an additional program which polls a vulnerability list source on a regular basis, or in subsequent updates to a runtime, thereby enabling an administrator to see what vulnerable software is currently running on a system; these actions are examples of “vulnerability detection”. Vulnerability notifications can be exposed using an OS logging mechanism, or via configured external reporting endpoints, for example.

Some embodiments perform a runtime check which compares the currently loaded program framework and dependency tree, as a utilizable components list, against a vulnerabilities list of superseded software. The utilizable components list may be baked into the runtime, or be updated via an external service which places the lists in a previously specified location (in volatile or non-volatile storage, or both), for instance. The runtime may log alerts in a known, configurable location, from which they can be monitored or exposed. Optionally the runtime can be configured to download new versions of itself or its components, and to restart applications to patch any runtime security updates. Dependencies downloads and updates could also be configured as an optional feature.

An integration of vulnerability checks into the runtime tends to improve the operational functionality of a computing system. Integration means less configuration for admins, which reduces omissions and errors. It also allows a vendor to deliver updated checks with each runtime, without a user having to run an extra service such as Microsoft Update™ or the like, which keeps functionality current with new features and bug fixes. Moreover, integrated vulnerability checks allow users to point to an internally curated vulnerability list to allow flagging of their own internal libraries and dependencies, as well as third-party components.

Some embodiments described herein may be viewed by some people in a broader context. For instance, concepts such as detection, notification, privacy, security, and utilization may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to prioritize alerts. Other configured storage media, systems, and methods involving detection, notification, privacy, security, or utilization are outside the present scope. Accordingly, vagueness, mere abstractness, lack of technical character, and accompanying proof problems are also avoided under a proper understanding of the present disclosure.

Technical Character

The technical character of embodiments described herein will be apparent to one of ordinary skill in the art, and will also be apparent in several ways to a wide range of attentive readers. Embodiments address technical activities that are rooted in computing technology, potentially including a wide range of software components in a utilizing system. Some privacy-protecting vulnerability detection and notification embodiments improve the functioning of computing systems by automatically detecting vulnerable components and providing access to superseding versions whose functionality is corrected or enhanced, while protecting privacy of the utilizing system. Detecting and updating vulnerable components makes systems operate more securely, efficiently, and effectively. When the availability of patches or replacements for a vulnerable component is not detected, time and resources may be wasted by trying to identify, fix, or work around bugs or security weaknesses that have already been addressed by the component's vendor. By operation of the vulnerability detection and notification mechanisms and techniques taught herein, the functionality of component utilizing systems will be improved because vulnerabilities known to the vendor will be given prompt attention by local developers or admins, instead of being ignored or being acted upon much later. The sooner a security vulnerability is detected and acted upon, the more its adverse impact can be limited. With rapid vulnerability notification, an exploit may be avoided, or it may be confined to a single machine instead of an entire subnet, for example.

Other aspects and advantages of the technical characteristics of the teachings will also be apparent to one of skill from the description provided.

Acronyms, Abbreviations, and Names

Some acronyms, abbreviations, and names are defined below. Others are defined elsewhere herein, or do not require definition here in order to be understood by one of skill.

ALU: arithmetic and logic unit

API: application program interface

BIOS: basic input/output system

CD: compact disc

CLI: common language infrastructure

CPU: central processing unit

CVE: common vulnerabilities and exposures

DVD: digital versatile disk or digital video disc

FPGA: field-programmable gate array

FPU: floating point processing unit

GAC: global assembly cache

GPU: graphical processing unit

GUI: graphical user interface

HTTPS: hypertext transfer protocol secure

IDS: intrusion detection system generally, may be a HIDS (host-based IDS) or a NIDS (network-based IDS), for example

IoT: internet of things

IP: internet protocol

LAN: local area network

MVC: model view controller

OS: operating system

RAM: random access memory

REST: representational state transfer

RFC: request for comments

ROM: read only memory

SDK: software development kit

SHA256: 256-bit hash produced by secure hash algorithm

SOAP: simple object access protocol

TLS: transport layer security

UEFI: Unified Extensible Firmware Interface

URI: uniform resource identifier

VM: virtual machine

VS: Visual Studio® program (mark of Microsoft Corp.)

VS Code: Visual Studio® Code program (mark of Microsoft Corp.)

WAN: wide area network

XML: extensible markup language

Note Regarding Hyperlinks

Portions of this disclosure contain URIs, hyperlinks, IP addresses, and/or other items which might be considered browser-executable codes. These items are included in the disclosure for their own sake to help describe some embodiments, rather than being included to reference the contents of the web sites or files that they identify. Applicant does not intend to have these URIs, hyperlinks, IP addresses, or other such codes be active links. None of these items are intended to serve as an incorporation by reference of material that is located outside this disclosure document. Thus, there should be no objection to the inclusion of these items herein. To the extent these items are not already disabled, it is presumed the Patent Office will disable them (render them inactive as links) when preparing this document's text to be loaded onto its official web database. See, e.g., United States Patent and Trademark Manual of Patent Examining Procedure § 608.01(VII).

Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

Cybersecurity may be viewed as a proper subset of security in general, in that cybersecurity is focused on protecting the availability, confidentiality, integrity, privacy, or other desirable aspect of digital information, and protecting computing resources such as access to processors or bandwidth. Information assurance is the practice of assuring information by managing risks related to the use, processing, storage, or transmission of information; the information may be digital or analog. However, for convenience and breadth, the terms “security”, “cybersecurity”, and “information assurance” are used interchangeably herein to encompass risk identification and risk management with regard to digital or analog information. Thus, for present purposes each of these terms includes, for example, identifying and managing risks related to the use, processing, storage, or transmission of digital or analog information, and likewise includes for example administrative, technical, or physical controls used to help protect the availability, confidentiality, or integrity of such information.

As used herein, “privacy” means the controlled confidentiality, integrity, availability, or use of information pertaining to a particular entity.

As used herein, a “computer system” may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code. Code which must be interpreted or compiled in order to execute is referred to as “source code”.

“Program” is used broadly herein, to include applications, kernels, drivers, interrupt handlers, firmware, state machines, libraries, and other code written by programmers (who are also referred to as developers) and/or automatically generated.

“Service” means a consumable program offering in a cloud computing environment or other network or computing system environment.

“Cloud” means pooled resources for computing, storage, and networking which are elastically available for measured on-demand service. A cloud may be private, public, community, or a hybrid, and cloud services may be offered in the form of infrastructure as a service, platform as a service, software as a service, or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing nodes. Such nodes are examples of computer systems as defined herein, but they also have at least two of the following characteristics: (a) no local human-readable display; (b) no local keyboard; (c) the primary source of input is sensors that track sources of non-linguistic data; (d) no local rotational disk storage—RAM chips or ROM chips provide the only local memory; (e) no CD or DVD drive; (f) embedment in a household appliance; (g) embedment in an implanted medical device; (h) embedment in a vehicle; (i) embedment in a process automation control system; or (j) a design focused on one of the following: environmental monitoring, civic infrastructure monitoring, industrial equipment monitoring, energy usage monitoring, human or animal health monitoring, or physical transportation system monitoring.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Operations such as communicating with a vulnerabilities base API or a logging mechanism, computing a truncated hash or fingerprint, utilizing a software component, formatting data, and executing code, are understood herein as inherently digital. A human mind cannot interface directly with a CPU or other processor, or with RAM or other digital storage, to read and write the necessary data to perform the vulnerability detection and notification steps taught herein. This would be well understood by persons of skill in the art in view of the present disclosure, but others may sometimes need to be informed or reminded of the facts. Unless stated otherwise, embodiments are also presumed to be capable of operating at scale (i.e., operating on event data from one hundred or more monitored devices) in production environments, or in testing labs for production environments, as opposed to being mere thought experiments.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as adding, aggregating, anonymizing, ascertaining, avoiding, building, comparing, computing, connecting, communicating, configuring, creating, denoting, deploying, determining, displaying, employing, executing, exporting, generating, getting, identifying, indicating, installing, listing, loading, maintaining, masking, notifying, obtaining, operating, placing, providing, pulling, receiving, requesting, responding, running, selecting, sending, specifying, taking, tokenizing, updating, using, utilizing (and adds, added, aggregates, aggregated, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as computational system or computing system

104 users

106 peripherals

108 network generally, including, e.g., LANs, WANs, software defined networks, and other wired or wireless networks

110 processor

112 computer-readable storage medium, e.g., RAM, hard disks

114 removable configured computer-readable storage medium

116 instructions executable with processor; may be on removable storage media or in other memory (volatile or non-volatile or both)

118 data

120 kernel(s), e.g., operating system(s), BIOS, UEFI, device drivers

122 tools, e.g., anti-virus software, firewalls, packet sniffer software, intrusion detection systems (IDS), intrusion prevention systems (IPS), software development tools and tool suites, hardware development tools and tool suites, diagnostics

124 applications, e.g., word processors, web browsers, spreadsheets, games, email tools

126 display screens, also referred to as “displays”

128 computing hardware not otherwise associated with a reference number 106, 108, 110, 112, 114

202 component utilizing system, namely, a system 102 configured with one or more components which it may “utilize” through project building, deployment, loading, execution, debugging, static analysis, dynamic analysis, profiling, or another operation that manages one or more computational resources

204 component, e.g., dynamic-link library, plug-in, tool extension, assembly, package, object code file, executable code file, resource file, driver, handler, or other bounded collection of instructions or data or both which can be utilized on some system

206 component utilizer, e.g., project building tool, deployment tool, loader, kernel, runtime, application, debugger, code analysis tool, or profiler

208 component updater, namely, tool which supplements or replaces or patches one version of a component to provide a functionally overlapping but not identical version of the component

210 utilizable component, namely, a component 204 which is utilizable by the component utilizing system 202 on which is resides, in that either (a) the component and the system are configured to be a single command, request, response, or operation away from utilization of the component on or by the system, or (b) the system is currently utilizing the component

212 list of one or more utilizable components, e.g., a linked list, array, tree, manifest, XML recitation, file, or other data structure which includes, names, addresses, identifies, or otherwise specifies one or more utilizable components

214 logging infrastructure, e.g., kernel logging software, kernel log, syslog format log, software for creating or updating a syslog format log, logging daemon, or logging agent; 214 may also refer to the act of logging

216 vulnerabilities base, also referred to herein as “vulnerable components list source”

218 vulnerable component, namely, component 204 which has one or more vulnerabilities that are known to at least one of: the component's author, a vendor of the component, or the public; a vulnerable component may also be referred to as a “bad” component

220 list of one or more vulnerable components, e.g., a linked list, array, tree, manifest, XML recitation, file, or other data structure which includes, names, addresses, identifies, or otherwise specifies one or more vulnerable components

222 component vendor; the vendor of a given component may be an individual, a corporation, institution, agency, or another entity which created, published, or documented the component

224 vulnerability, e.g., a weakness in a component which can be exploited by a threat actor to obtain unauthorized control over or access to data or a computing resource; also referred to as a “security vulnerability” because vulnerabilities often impact the confidentiality, availability, integrity, or privacy of data or computing resources (processing power, storage, network)

226 notification of a vulnerability, e.g., in a communication to a human administrator or to security software such as an intrusion prevention system; may also be called a “warning”

228 provider (specialized software running on hardware) of one or more vulnerability notifications

230 feed server, namely, software which provides a vulnerable components list in the form of a feed

232 feed, e.g., Atom or RSS (variously understood to mean “Rich Site Summary” or “Really Simple Syndication”) feed

234 request for a list of vulnerable components; may be implemented, e.g., using REST, RSS, SOAP, XML, APIs, or other protocols and mechanisms

236 response to request for a list of vulnerable components; may be implemented using one or more protocols and mechanisms listed for request 234; response may include errors codes, metadata, other data instead of or in addition to a list of vulnerable components

238 command from a vendor to a vulnerabilities base to add, delete, or modify a description of a vulnerable component for use in vulnerable component lists; may be implemented, e.g., using REST, RSS, SOAP, XML, APIs, or other protocols and mechanisms; command response may be considered part of the command for present purposes

240 utilization base, namely, a database, repository, or other information base which documents usage of components; may reside at a vendor

242 component usage data; may include (a) data from a component utilizer about what component version is installed in what context (e.g., kernel, utilizer ID, environment variables, configuration settings), (b) data from a component such as execution events, or (c) both; unlike telemetry 244, the usage data may be anonymized, e.g., through masking, tokenization, aggregation permitting only statistical analyses

244 raw telemetry from a component utilizer, a component, or both

246 telemetry anonymizer which protects privacy of the component utilizer and component utilizing system, e.g., by stripping out IP addresses, owner metadata, and other information which is inherently specific to the component utilizer or the component utilizing system, or through masking, tokenization, aggregation permitting only statistical analyses, or through a combination of anonymizing or privacy-protecting operations or both

248 telemetry exporter which sends raw telemetry from a component utilizing system toward a utilization base

302 description of a vulnerable component; may be in human-readable or binary form; includes or at least implies a version number or other version identification, and also identifies one or more known vulnerabilities 224 of the identified version of the component

304 metadata associated with or pertaining to a vulnerable component

306 component version number, patch level, or other version identification

308 security vulnerability identification or description, e.g., text, hyperlink to website description, or CVE identifier

310 hyperlink to an updated version of the component which removes or mitigates a known vulnerability of a stated version of the component; the hyperlink may use security measures such as HTTPS or TLS, for example

402 description of a utilizable or potentially utilizable component; may be in human-readable or binary form; includes or at least implies a version number or other version identification

404 metadata associated with or pertaining to a utilizable or potentially utilizable component

502 ID, address, index number, IP address, or other direct or indirect identification of a particular requester, namely, a particular component utilizing system or particular component utilizer which requested or is requesting a vulnerable components list

504 set of two or more vulnerable component descriptions

506 subset selector, e.g., a truncated hash, fingerprint, or other data which identifies a set of two or more vulnerable component descriptions; 506 also refers to an act of selecting a subset, based on a selector or a constraint 508 or both; a subset is a kind of set, so space limitations in FIG. 5 are met in part by showing “set 504” rather than “subset 504”; a “proper subset” P of a set X is a set whose members are all in X and which does not contain every member of X

508 date constraint, kernel compatibility constraint, or other constraint which constrains a search result of vulnerable component descriptions; a set selector may be viewed as a constraint but is called out separately because set selectors do not have semantic meaning whereas constraints such as vulnerability publication date and component kernel compatibility do have semantic meaning

602 extensible development tool, e.g., Visual Studio® tool, Visual Studio® Code tool (mark of Microsoft Corp.), Xcode® tool (mark of Apple Computer, Inc.), Android® Studio tool (mark of Google, LLC), and others

604 runtime system, also referred to herein as “runtime”; some examples include Common Language Runtime, Android® Runtime (a.k.a. ART) (mark of Google, LLC), Java® virtual machine (a.k.a. JVM) (mark of Oracle America, Inc.); the Microsoft .NET™ Framework also provides a widely used runtime; a software development kit 608 may also provide or serve as a runtime in some embodiments; the term “runtime” also means execution time as opposed to compile time, depending on context (runtime as a system versus runtime as a time period)

606 software generally

608 software development kit

610 project generally

612 project building tool

614 software deployment tool

616 integrated development environment

618 cloud generally; may be private, public, community, or hybrid

620 cloud infrastructure, e.g. management plane, microservice, APIs published by a cloud provider, or a hypervisor (type I or type II)

622 code component repository, e.g., a repository to facilitate collaboration between developers and to provide version control; some of the most widely used web-based repositories, which provide services for source code and development project hosting, include GitHub® (mark of GitHub, Inc.), BitBucket® (mark of Atlassian Pty Ltd), and SourceForge® (mark of SourceForge Media, LLC)

702 infrastructure-as-a-service (IaaS or IAAS) operating environment

704 platform-as-a-service (PaaS or PAAS) operating environment

706 software-as-a-service (SaaS or SAAS) operating environment

708 non-cloud operating environment, e.g., on-premises environment that lacks one or more characteristics of a “cloud” as defined herein (pooled resources for computing, storage, and networking which are elastically available for measured on-demand service)

802 log, e.g., log file

804 syslog standard for logging, as defined in Internet Engineering Task Force RFC 5424

806 mechanism (e.g., software with supporting hardware) which operates in a manner compliant or consistent with the syslog standard for logging

808 log format

810 SIEM/SIM/SEM tool, namely, a security information and event management tool

902 package, in the sense of a software package, which is a software distribution artifact

904 publisher of software package

906 software package version; may include one or more component versions for components archived in the package or for the overall package itself

908 digital signature of software package publisher

910 cryptographic hash of software package

912 manifest (list of contents) of software package

914 software assembly, e.g., one or more components containing data type definitions and other program resources

916 software assembly version; may include one or more component versions for components in the assembly or for the overall assembly itself

918 cryptographic hash of software assembly

920 extension; may also be referred to as “plug-in” or “add-on”; e.g., extension for adding functionality to an extensible development tool

922 extension metadata, e.g., version, publisher, user documentation

1000 example of a vulnerability detection and notification method

1002 obtain vulnerable components list

1004 get utilizable components list

1006 compare vulnerable components list with utilizable components list to see what is on both lists

1008 generate vulnerability notification

1010 update a system to patch or replace or delete a component

1012 remove a vulnerability by patching or replacing or deleting a component; removal need not be complete—mitigating a risk by decreasing the potential adverse impact of an exploit through the vulnerability is a partial removal of the vulnerability and hence within the scope of removal 1012

1014 specify a constraint 508

1016 specify a set selector 506

1018 employ a privacy protection

1020 a privacy protection, e.g., anonymization, masking, tokenization, aggregation, withholding (i.e., avoiding supplying) identifying information

1022 ascertain overlap of vulnerable and utilizable lists, namely, components which are listed both as vulnerable and as utilizable

1024 overlap of vulnerable and utilizable lists, namely, components which are listed both as vulnerable and as utilizable; this overlap is also referred to as “vulnerable utilizable components” or as “utilizable vulnerable components”

1102 component utilization event, namely, any event in which a utilizable component is actually utilized during project building, deployment, loading, execution, debugging, static analysis, dynamic analysis, profiling, or another operation that manages one or more computational resources

1104 context of a component utilization in general, which may include a particular utilizer 206, a particular utilizing system 202, or both, for example

1106 development tool workspace

1108 dependency, e.g., this component depends on, or this component is depended on

1200 flowchart

1202 identify component version

1204 denote a security vulnerability

1206 notify user that a security vulnerability is known

1208 pull an entire list of vulnerabilities, possibly subject to a constraint or set selector

1210 install a component

1212 utilize a component

1214 operate a system or portion of a system in an environment

1216 export telemetry from a system

1218 aggregate telemetry to remove system-specific identifiers

1220 avoid maintaining system-specific utilization record (may retain aggregate info, or anonymized info)

1222 avoid exporting telemetry to the vulnerability base

1224 provide information to a security service

1226 security service

1228 respond to a utilization event

1230 add a component to a project or workspace

1232 load a component for execution

1234 include a component in a build

1236 select a component for deployment

1238 deploy a component

1240 avoid supplying a identifier which is specific to a component

1242 add or change a vulnerability description

1244 send data to another system or another portion of a system

1246 receive data from another system or another portion of a system

1248 update a component, e.g., by replacing the component with a different version of the component, or by patching the component

1250 build a project or an executable

1252 traverse dependency graph to identify additional utilizable components; although shown in the same box as identify 1202 version in FIG. 12, due to space limitations, they may be considered separate steps

1254 anonymize telemetry

1256 execute, start, or launch an application or another program

Operating Environments

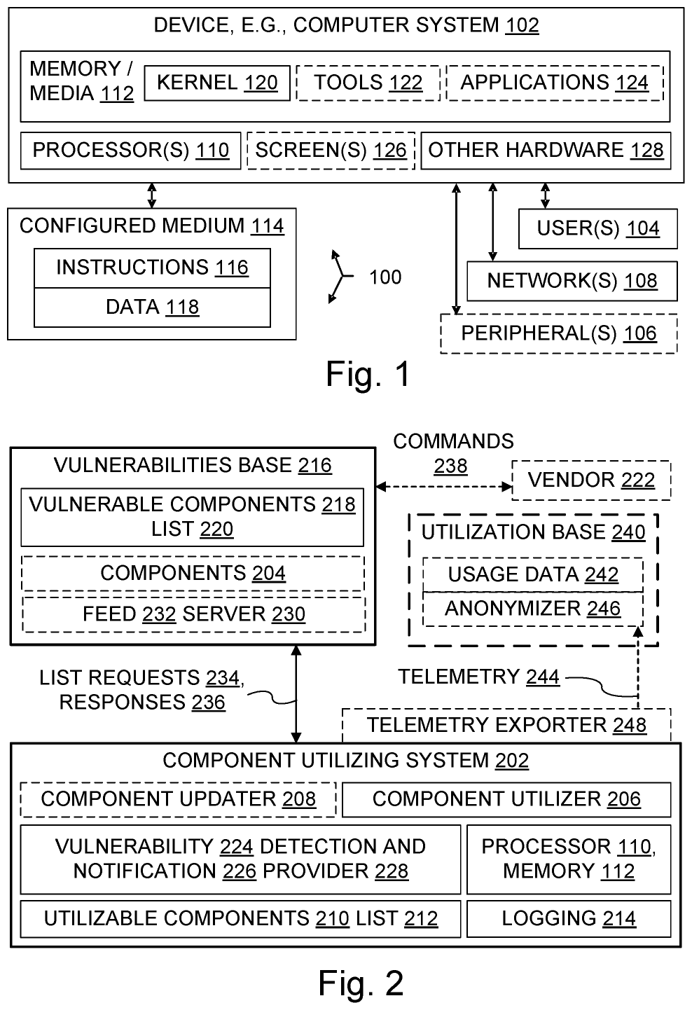

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security personnel, operations personnel, developers, engineers, auditors, and end-users are each a particular type of user 104. Automated agents, scripts, playback software, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

A given operating environment 100 may include an Integrated Development Environment (IDE) 616 which provides a developer with a set of coordinated computing technology development tools such as compilers, source code editors, profilers, debuggers, layout tools, simulators, and so on. In particular, some of the suitable operating environments for some software development embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but many teachings herein are applicable with a wide variety of programming languages, programs, programming models, development tools, and development methodologies.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software defined network. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

Examples are provided herein to help illustrate aspects of the technology, but the examples given within this document do not describe all of the possible embodiments. Embodiments are not limited to the specific implementations, arrangements, displays, features, approaches, or scenarios provided herein. A given embodiment may include additional or different technical features, mechanisms, sequences, data structures, or functionalities for instance, and may otherwise depart from the examples provided herein.

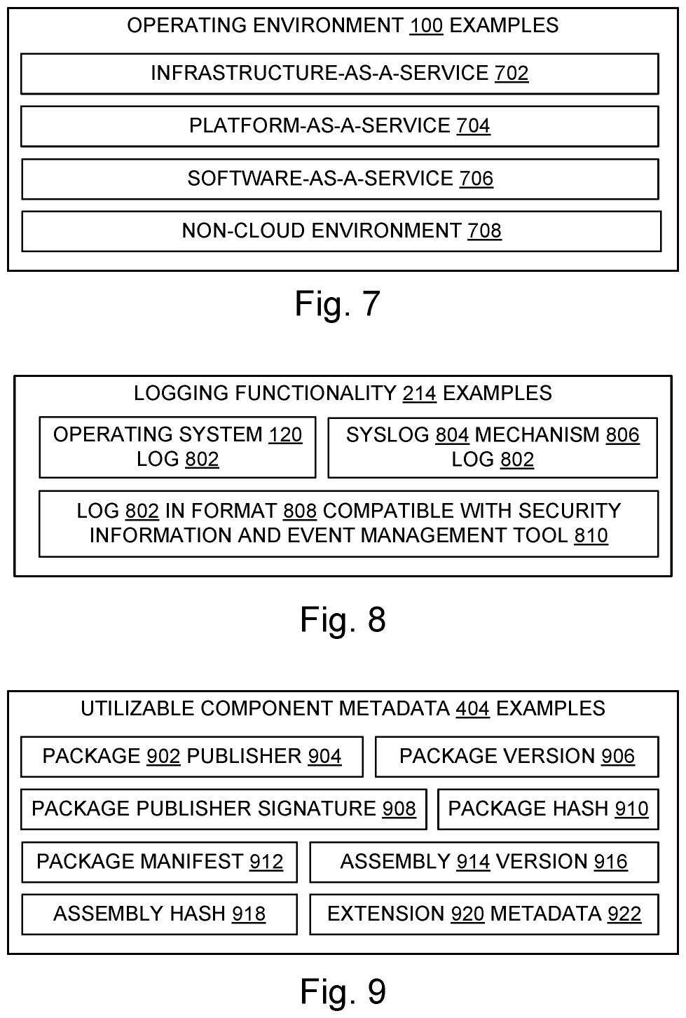

FIGS. 2-9 and 11 illustrate aspects of some architectures that are suitable for embodiments taught herein. A component utilizing system 202 includes one or more component utilizers 206 which utilize components 204. Components come in many forms and may be utilized in many ways; FIG. 6 shows some examples of component utilizers 206, while FIG. 7 illustrates some examples of operating environments 100 in which components can be utilized, and FIG. 11 shows some component utilization contexts within one or more operating environments.

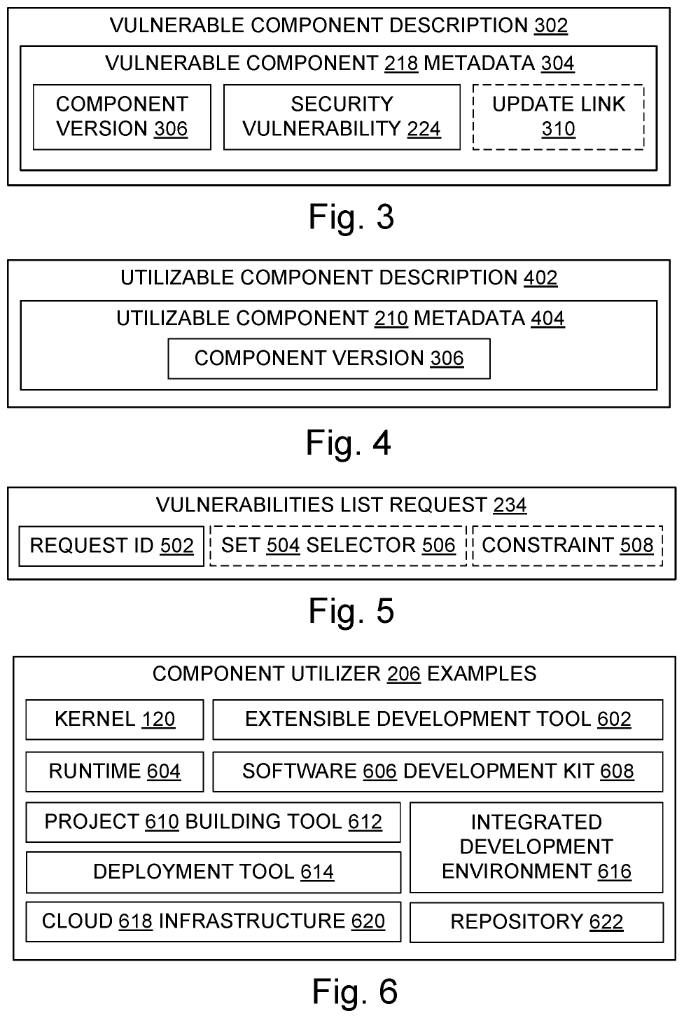

Unfortunately, components sometimes have vulnerabilities 224 which may be exploited to attack the confidentiality, availability, integrity, or privacy of data 118 or of system resources such as resources 108, 110, 112, 120, 122, 124, 126, 128. A component vendor 222 may discover or learn of such vulnerabilities, and may publish a description 302 which documents a vulnerability in a particular version 306 of a component. FIG. 3 illustrates aspects of some vulnerable component descriptions. As shown in FIG. 4, utilizable components also have descriptions 402, which likewise include component version 306 information.

However, documenting the vulnerability does not inherently notify all utilizers 206 of the vulnerability. To mitigate the gap between vendor publication of a vulnerability and utilizer notice of that vulnerability, a vulnerability detection and notification provider 228 on some systems requests 234 vulnerability lists 220 from a vulnerabilities base 216. FIG. 5 illustrates aspects of some requests for a vulnerability list 220. As used herein, list 220 refers to an entire list stored at a vulnerabilities base 216, or a copy thereof at some location or in transit, or to a portion of such list, which may also be at the vulnerabilities base or elsewhere, or in transit.

A naïve approach to such requests 234 for vulnerability information might attempt to optimize the communications 234, 236 and processing involved by sending the vulnerabilities base a list 212 of the components that are actually in place on the system 202 and asking the vulnerabilities base 216 whether any of these components 210 have known vulnerabilities. But this naïve approach gives the vulnerabilities base detailed configuration information about the system 202, which may be an undesirable result for various reasons. Detailed configuration information about a system 102 makes attacks on the system easier; this is why potential attackers perform “footprinting” reconnaissance on a target system, for example. Even if the people operating the vulnerabilities base have no intent to attack the system 202, sending detailed configuration information about system 202 to the vulnerabilities base would make the security of the system 202 depend on the security of the vulnerabilities base, which is likely outside the control of the people responsible for system 202 security. Detailed configuration information also facilitates targeted advertising. Configuration details may also be considered trade secrets. For these reasons, or others, people using or managing the system 202 may be understandably reluctant to send detailed configuration information, such as installed component version 306 data or metadata 404, to a vulnerabilities base, even if valuable vulnerability information 220 is provided in return.

Accordingly, some embodiments described herein use or provide technical measures (also called “privacy protections” 1020) to protect the privacy of system 202 configuration information. For example, the detection and notification provider 228 may request a full list 220 of all known vulnerabilities, or request a portion of the list which matches a kernel compatibility or publication date constraint 508, without also identifying to the vulnerabilities base which components and which versions are present on the system 202. Alternately or in addition, detailed configuration information may be sent to the base 216 but not be retained in the base after the responsive vulnerabilities list 220, 236 is sent to the system 202. Alternately or in addition, detailed configuration information may be sent to the base 216 but be aggregated with configuration information from other systems, to allow statistical analysis of aggregated data without revealing the configuration details of any particular system. Alternately or in addition, detailed configuration information may be masked, or anonymized 1254, or even tokenized. Alternately or in addition, a subset 504 of the available full list 220 of vulnerabilities may be requested, using a truncated hash or fingerprint as a selector 506, so that information about vulnerabilities of an installed component is sent from the vulnerabilities base 216 in the midst of, and thus obscured or obfuscated by, vulnerabilities of other components which may or may not also be installed but which happen to have the same truncated hash or fingerprint as the installed component of interest.

As also illustrated in FIG. 2, in some cases detailed configuration information is exported from the system 202 to a utilization base 240, in the form of telemetry 244. Telemetry may include, for example, utilizable component metadata, as illustrated in FIG. 4 and FIG. 9. The telemetry may be exported as a network communication, or by being logged 214 at a location which is also accessible to the utilization base 240. FIG. 8 illustrates some aspects of logging.

Despite the exporting, desired privacy levels for system 202 configuration details may be maintained in one or more of the following ways. Other privacy protections may also be used, consistent with the teachings herein.

First, the telemetry is not sent to the vulnerabilities base 216 but is instead sent to a utilization base 240. The utilization base 240 may have tighter security than the vulnerabilities base 216. Also, the utilization base 240 may be under the security control of a particular vendor 222, whose reputational and financial interests urge effective privacy protection measures.

Second, privacy of exported telemetry may be maintained by privacy protection measures, e.g., through an anonymizer 246 which transforms raw telemetry into usage data 242 which is free of system-specific identifiers. Privacy protection measures may be used in combinations, including technical measures discussed above for use at the vulnerabilities base 216. Some examples include masking, aggregating, and non-maintenance of system-specific identifiers beyond a short time period (e.g., one hour) or a current communication session.

Some embodiments use or provide a computing system 202 configured for private proactive vulnerability detection, with the computing system including a processor 110, a memory 112 in operable communication with the processor, a component utilizer 206, and a vulnerability detection and notification provider 228. Upon execution by the processor, the provider 228 obtains a vulnerable components list 220 which includes multiple vulnerable component descriptions 302. Each vulnerable component description includes vulnerable component metadata 304 which identifies a particular version 306 of a vulnerable component 218, 204 and also includes vulnerability metadata 304 which denotes a particular security vulnerability 224 of the identified particular version of the vulnerable component. This provider 228 also compares at least a portion of the vulnerable components list 220 to a utilizable components list 212. The utilizable components list includes multiple utilizable component descriptions 402. Each utilizable component description includes utilizable component metadata 404 which identifies a particular version 306 of a utilizable component 210, 204 which is installed on the computing system 202 or is otherwise available to the component utilizer 206 for utilization on the computing system 202. This provider 228 also generates a vulnerability notification 226 that is formatted to notify a user 104 of the computing system 202 that at least one utilizable component 210, 204 is also a vulnerable component 218, 204. In this example, the vulnerable components list 220 includes at least one component 218, 204 that is not also a utilizable component 210, 204. One of skill will acknowledge, for instance, that pulling an entire feed or other list 220 of bad packages 218 is one way to include at least one component that is not also a utilizable component.

In some embodiments, the component utilizer 206 includes at least one of the following: a kernel 120, a runtime 604, an extensible development tool 602, a deployment tool 614, a project building tool 612, a software development kit 608, or an integrated development environment 616.

In some embodiments, the component utilizer 206 operates in an infrastructure-as-a-service environment 702, 100 and the vulnerable components list identifies at least one infrastructure component 204. In some, the component utilizer 206 operates in a platform-as-a-service environment 704, 100 and the vulnerable components list identifies at least one kernel component 204. In some, the component utilizer 206 operates in a software-as-a-service environment 706, 100 and the vulnerable components list identifies at least one application component 204.

In some embodiments, the vulnerability notification 226 includes at least one of the following: an operating system log 802, a syslog mechanism 806 log 802, or a log 802 in a format 808 compatible with a security information and event management tool 810. OS logging infrastructure is one example of logging functionality 214 which is suitable, and may be used in some embodiments. In some embodiments, vulnerable components lists 220 may also be communicated via logging functionality 214.

Some embodiments include a components updater 208 which updates one or more utilizable vulnerable components, thereby removing 1012 at least one vulnerability 224 from the computing system 202. Updating may be accomplished by component replacement, by component patching, or both.

Some embodiments include a components telemetry exporter 248 which upon execution by the processor exports from the computing system 202 at least a portion of the utilizable components list 212. In some embodiments, telemetry 244 specifies about what's installed on the system 202, and is not necessarily limited to specifying installed bad packages or other vulnerable components 218 of the system 202. In some embodiments, telemetry 244 may, alternately or in addition to such installation/presence/availability for utilization info, include event telemetry info such as Event Tracing for Windows (ETW) events generated by utilized components. Such event telemetry 244 may be analyzed to detect malicious activity, or performance weaknesses, for instance.

In some embodiments, the utilizable component metadata includes at least a specified number (one, two, three, and so on up to all eight) of the following kinds of component metadata: a package publisher 904, a package version 906, a package publisher signature 908, a package hash value 910, a package contents manifest 912 identifying assemblies of the package, an assembly version 916, extension metadata 922, or a hash value 918 of one or more assemblies 914.

Other system embodiments are also described herein, either directly or derivable as system versions of described methods or configured media, informed by the extension discussion herein of computing hardware.

Methods

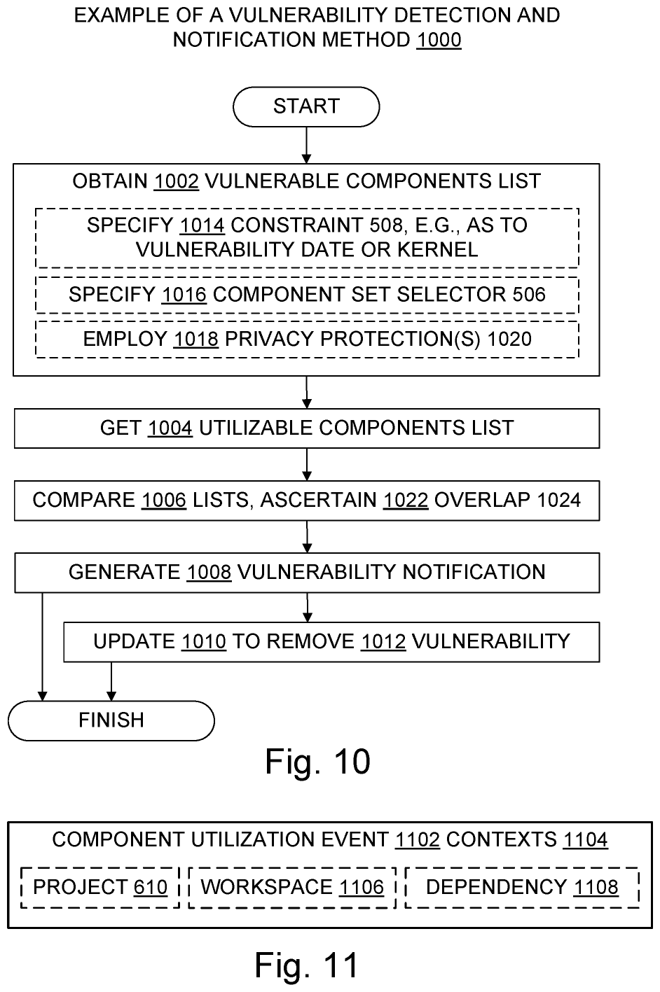

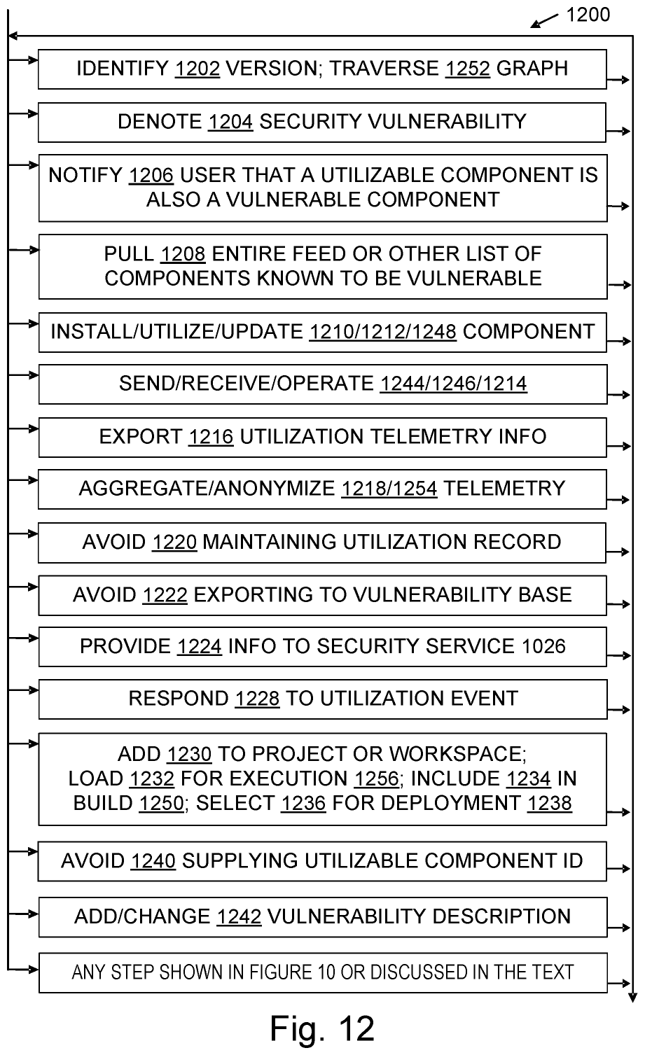

FIG. 10 illustrates an example method 1000 for vulnerability detection and notification. An entity performing the method 1000 obtains 1002 a vulnerable components list, gets 1004 a utilizable components list, compares 1006 to list to find components that appear on both lists in the same version 306, and generates 1008 a notification reporting those vulnerable utilizable components. Getting 1004 the utilizable components list may include recognizing dependencies 1108, and may include gathering components recursively. Some methods also update 1010 vulnerable utilizable components.

In some cases, the method protects 1018 system configuration privacy when it obtains 1002 the list of vulnerable components, e.g., by not specifying 1240 any particular utilizable components to the source 216 of the vulnerable components list. Privacy may also be protected 1018 by specifying 1016 only a subset 504 of components to the source of the vulnerable components list, so the source 216 does not know which particular components of that set are being utilized on the requesting system 202.

Technical methods shown in the Figures or otherwise disclosed will be performed automatically, e.g., by a component utilizer 206 enhanced with vulnerability detection and notification functionality 228, unless otherwise indicated. Methods may also be performed in part automatically and in part manually to the extent action by a human administrator or other human person is implicated, e.g., entering a command to detect and display any vulnerable components 218 of a project 610 or a runtime 604. No method contemplated as innovative herein is entirely manual. In a given embodiment zero or more illustrated steps of a method may be repeated, perhaps with different parameters or data to operate on. Steps in an embodiment may also be done in a different order than the top-to-bottom order that is laid out in FIGS. 10 and 12. Steps may be performed serially, in a partially overlapping manner, or fully in parallel. In particular, the order in which flowchart 1200 items are traversed to indicate the steps performed during a method may vary from one performance of the method to another performance of the method. The traversal order may also vary from one method embodiment to another method embodiment. Steps may also be omitted, combined, renamed, regrouped, be performed on one or more machines, or otherwise depart from the illustrated flow, provided that the method performed is operable and conforms to at least one claim.

Some embodiments use or provide a method for private proactive vulnerability detection. This method includes proactively obtaining 1002, from a vulnerable components list source, a vulnerable components list which includes multiple vulnerable component descriptions. Each vulnerable component description includes vulnerable component metadata which identifies 1202 a particular version of a vulnerable component and also includes vulnerability metadata which denotes 1204 a particular security vulnerability of the identified particular version of the vulnerable component.

This method also includes proactively getting 1004 a utilizable components list which includes multiple utilizable component descriptions. Each utilizable component description includes utilizable component metadata which identifies 1202 a particular version of a utilizable component which is installed 1210 on a particular computing system or is otherwise available for utilization 1212 on the particular computing system. The vulnerable components list includes at least one component that is not also a utilizable component.

This method also includes comparing 1006 at least a portion of the vulnerable components list to at least a portion of the utilizable components list, thereby ascertaining 1022 one or more utilizable vulnerable components 1024, 204, namely, one or more components 204 which are on both the vulnerable components list 220 and the utilizable components list 212. This method also includes generating 1008 a vulnerability notification that names at least one utilizable vulnerable component 1024.

In some embodiments, a runtime 604 itself generates either or both of the lists 212, 220. In particular, a runtime may generate a vulnerable components list 220 for components developed locally on the system 202. More generally, depending on the embodiment, a runtime may produce either or both lists 212, 220, and may use either or both lists itself or supply either or both lists to another piece of software such as a security service.

In some embodiments, the method includes placing 1014 at least one date constraint 508 which limits content of the vulnerable components list. For example, the request 234 may be limited to vulnerabilities published after date X, or to vulnerabilities between date X and date Y.

In some embodiments, the method includes the vulnerable components list source 216 avoiding 1220 maintaining any record which indicates that a particular component 204 is one of the utilizable components 210 of the particular computing system 202. Thus, privacy is protected having the source 216 not remember which components are on a particular system even if it received that configuration information in a request 234. The configuration information could be restricted to volatile memory, for example, or be securely deleted (e.g., overwritten or crypto-shredded) after the response 236 is sent, or both.

In some embodiments, obtaining 1002 the vulnerable components list includes sending 234 the vulnerable components list source 216 a component set selector 506 which specifies 1016 a component set 504 having a plurality of components which includes at least one of the particular computing system's utilizable components 210, without specifying 1240 any particular individual utilizable component. This allows the system 202 to acquire a set of component vulnerabilities, instead of the vulnerability for a particular component.

In some cases, the set selector 506 is implemented as a fingerprint. A fingerprint, is similar to a cryptographic hash in that each maps an arbitrary amount of data to a fixed size and often much smaller value in a one-way transformation. However, fingerprints can be computed faster than hashes that are suitable for cryptographic use. A fingerprint set selector 506 may be computed from a utilizable component using, e.g., Rabin's fingerprinting algorithm. Fingerprints, and hashes in general, may be computed from the binary content of a component, from the component's metadata, or from both.

In some cases, the set selector 506 is implemented as a truncated hash. A truncated hash is derived from a utilizable component by computing a hash of the component and then truncating it. For instance, a hash may be computed using any hash algorithm (whether suitable for cryptographic use or not) and then truncating to obtain only the lowest N of M bits. If a hash has already been computed for a component, e.g., as part of a code signature to help authenticate the component, then the hash need not be recomputed. The number of bits N to keep in the set selector 506 may be chosen such that the size of the corresponding subset 504 of components who have the same hash truncation is at least K. N may be determined experimentally, and iteratively, for a given K. For example, it may occur for certain components that when the untruncated hash is 256 bits in size and is truncated to an eight bit selector, the set tends to contain at least twenty components.

In operation, using a selector 506 allows the component utilizing system 202 to narrow down the list of vulnerable components sent in a response 236 without identifying a specific utilizable component 210 in the request 234 for that list. This protects system 202 private configuration information, such as package name and version, against being disclosed in the request 234. This allows the system 202 to check a specific utilizable component 210 against the list 220 of vulnerable components 218, without telling the vulnerabilities base 216 what is installed on the system 202. The system 202 derives a selector from the component 210 to be checked, sends that selector up to the vulnerabilities base 216, and the base 216 sends back a list of all bad components 218 that have the same derived value (e.g., fingerprint or truncated hash). The system 202 then looks for its component 210 in this partial list sent by the base 216. An advantage to this approach is that because the base 216 only ever gets information derived from the component 210 (not the identity of the component 210 itself), the base 216 generally can't recover the system 202's configuration.

In some embodiments, the comparing 1006 or the generating 1008 or both are performed in response to one or more of the following events: a utilizable component is added 1230 to a development project, a utilizable component is added 1230 to a development workspace, a utilizable component is loaded 1232 for execution, a utilizable component is included 1234 during an executable build operation, or a utilizable component is selected 1236 for deployment. To accomplish such response, the vulnerability detection and notification provider 228 may be integrated with a component utilizer such as a project building tool 612, a loader in a runtime 604 or integrated development environment 616, a deployment tool 614, or cloud infrastructure 620.

Some embodiments include exporting 1216 at least a portion of the utilizable components list from the particular computing system. Some include exporting events logged during operation 1214 of a component 210.

In some embodiments, a runtime proactively obtains 1002 the vulnerable components list. The runtime ascertains 1022 one or more utilizable vulnerable components, and the runtime also generates 1008 the vulnerability notification 226. In particular, a runtime may proactively generate security notifications to inform developers or administrators that their components have known vulnerabilities. In some cases, a runtime might not obtain the list directly; an additional service may obtain the list first and then place it where the runtime can check it. The additional service is not necessarily resident on the component utilizing system 202. For example, a cloud security center service 620 could obtain the list of vulnerable components from a repository 216, and then compare 1006 that vulnerability information against telemetry 244 the cloud security center service gathered from programs running in a customer's cloud subscription. More generally, some embodiments provide 1224 component metadata of utilizable vulnerable components to a cloud-based security service 1226, which is not necessarily part of the cloud infrastructure 620.

Some embodiments avoid 1222 exporting any of the utilizable component metadata to the vulnerable components list source 216. This is a privacy protection measure.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as a vulnerable components list 220, a utilizable components list 212, a vulnerability detection and notification provider 228, metadata 304, 404, logs 802, constraints 508, and set selectors 506, in the form of data 118 and instructions 116, read from a removable storage medium 114 and/or another source such as a network connection, to form a configured storage medium. The configured storage medium 112 is capable of causing a computer system to perform technical process steps for vulnerability detection and notification with privacy protections as disclosed herein. The Figures thus help illustrate configured storage media embodiments and process embodiments, as well as system and process embodiments. In particular, any of the process steps illustrated in FIG. 10 or 12, or otherwise taught herein, may be used to help configure a storage medium to form a configured storage medium embodiment.

Some embodiments use or provide a storage medium 112, 114 configured with code which upon execution by one or more processors performs a vulnerability notification method which includes receiving 1246 over a network connection a request 234 from a component utilizing system for a vulnerable components list, and sending 1244 a vulnerable components list toward the component utilizing system. The vulnerable components list 220 sent includes multiple vulnerable component descriptions 302, each vulnerable component description including vulnerable component metadata 304 which identifies 1202 a particular version 306 of a vulnerable component and also including vulnerability metadata which denotes 1204 a particular security vulnerability 224 of the identified particular version of the vulnerable component.

Here, as in other examples, the term “list” is used to describe both the vulnerable components list 220 on a vulnerabilities base 216 and contents of a response 236, even though the list in the response 236 which may well contain many fewer items than the list on the base 216 from which it was copied or derived. In other words, different lists 220 discussed herein may be full copies, partial copies, derivatives, or extensions, of one another, even though each is referred to as a “list”, and even if each is referred to using the same reference numeral 220. Similar considerations apply to the utilizable components lists 212.

In some embodiments, a method is further characterized by one or more (up to and including each) of the following privacy protections 1020: (a) the request 234 is free of any representation that a particular utilizable component is installed on the component utilizing system, (b) the request 234 is free of any representation that a particular utilizable component is included in a build on the component utilizing system, (c) the request 234 is free of any representation that a particular utilizable component is part of a development project on the component utilizing system, (d) the request 234 is free of any representation that a particular utilizable component is part of a development workspace on the component utilizing system, (e) the request 234 is free of any representation that a particular utilizable component is loaded for execution on the component utilizing system, and (f) the request 234 is free of any representation that a particular utilizable component is selected for deployment on the component utilizing system, or selected for deployment from the component utilizing system, or selected for deployment controlled by the component utilizing system.

In the context of methods and mechanisms taught herein, a request being “free of” a representation means that the request does not contain the representation, is not linked to the representation, is not contained within the representation, and is not functionally connected or associated with or reliant upon the representation. A “representation” may be implemented explicitly or implicitly, as data, as an assumption embodied in a data structure, or as functionality in the operation of a system, for example.

In some embodiments, receiving 1246 includes receiving a request containing a component set selector 506. In this example, the method further includes selecting 506 a component set 504 based on the component set selector, and sending 1244 includes sending vulnerable component descriptions 302 which correspond to components of the selected 506 component set.

In some embodiments, receiving includes receiving 1246 a request 234 containing at least one of: a date constraint 508, a kernel constraint 508. In this example, the method further includes selecting 506 vulnerable component descriptions based on the one or more request constraints, and the sending includes sending 1244 the selected vulnerable component descriptions 302 and avoiding sending vulnerable component descriptions which do not meet the one or more request constraints.

In some embodiments, the method further includes adding 1242 or changing 1242 a vulnerable component description in response to an authorized vulnerability update command 238.

Additional Examples and Observations

One of skill will recognize that not every part of this disclosure, or any particular details therein, are necessarily required to satisfy legal criteria such as enablement, written description, or best mode. Also, embodiments are not limited to the particular programming languages, tool contexts, identifiers, fields, class definitions, or other implementation choices described herein. Any apparent conflict with any other patent disclosure, even from the owner of the present innovations, has no role in interpreting the claims presented in this patent disclosure. With this understanding, which pertains to all parts of the present disclosure, some additional examples and observations are offered.

Some NuGet™ Package Manager Examples

Consistent with other teachings herein, some embodiments provide or use tools and techniques which flag runtimes as needing patches, e.g., using component management sites or tools such as NuGet™ (mark of Microsoft Corporation), a free and open-source package manager designed for a Microsoft development platform. Teachings herein are not limited to embodiments that use the NuGet capabilities. Some embodiments provide or use tools and techniques which flag packages 902 as needing patches, e.g., using component management sites 216 or tools such as NuGet offerings. Some embodiments provide or use tools and techniques which serve a list 220 of known bad runtimes and packages, e.g., by using component management sites or tools, in some cases with a content delivery network 108.

Some embodiments provide or use an agent 248 to send alerts to a reporting URI; this may be done, e.g., by an enhanced .NET Core™ runtime or other enhanced runtime 604. Some provide or use alerting or reporting or both through a web portal, virtual machines, web apps, or other cloud 618 constructs.

Some embodiments perform or use logging at app startup 1256, 1102 and generate 1008 vulnerability notifications 226 only when a runtime 604 or package 902 is out of date.

In some embodiments, checks 1000 pull 1208 an entire bad feed 232 (namely, a vulnerable components list 220 in feed form), rather than send information 404 up to a server 216, 230. In some embodiments, a bad feed 232 is integrated into an extensible development tool for dev alerting 1206. In some, a bad feed 232 may be consumed by a repository 622 of components for dev alerting 1206. In some, a bad feed 232 may be consumed by a developer's utilizer tool 602, 612, 614, 616 or kit 608 for dev alerting. In some, a bad feed 232 may be checked as a build task 1234, namely, part of a build. Some embodiments offer a kernel-specific detection and notification provider 228, e.g., a Linux® daemon (mark of Linus Torvalds).

Some embodiments go beyond notification 1206 by also updating 1248 vulnerable components to mitigate or otherwise remove 1012 vulnerabilities. Some embodiments support command line or other updating 1248.

With further regard to vulnerability alerting for NuGet™ packages, some embodiments provide a list of security vulnerable packages, and their contents, hosted on nuget dot org, or a similar list 220 hosted on another component management website. Such a list 220 can be consumed by vulnerability scanners from Microsoft or other vendors.

Some possible features of such enhanced component management websites 216 include the following. These are merely examples. Some sites 216 are configured to flag packages as containing security vulnerabilities, and include details 302 of the vulnerabilities and links 310 to updated packages which don't contain the vulnerability. Some support a staged update, with scheduling to permit coordination in Patch Tuesday or other scheduled update scenarios. Some sites 216 serve up a feed 232 of vulnerable packages, including their publisher, version, publisher signature, SHA256 of package, and the contents of the package, assemblies, assembly version, and SHA256 of assemblies. Hashes of other sizes than 256 bits may also be used, and hashes may be cryptographic hashes of other kinds than SHA (secure hash algorithm) hashes. Some sites 216 include a list 220 query mechanism based on flagging date, with etag support to allow clients to pull down 1208 a full list 220, to pull 1208 vulnerabilities published since X, or to pull 1208 vulnerabilities published between X and Y. No lookup is supported on package name, due to privacy concerns. Some sites 216 support an audit command 234 which pulls down updates to the list, caches locally and then compares 1006, and errors 1206 if vulnerable packages 218 are found. Locally (on system 202) cached updates to the list 220 are done based on date, to reduce load.

Some Observations About Dependencies

Some traverse 1252 dependencies 1108 of vulnerable components or traverse dependencies generally, in searches for vulnerable components. Some embodiments provide or use tools and techniques which check and flag bad dependencies 1108, e.g., in a suitably enhanced runtime such as an enhance .NET Core™ runtime (mark of Microsoft Corporation).

One of skill will acknowledge that dependencies 1108 may be embodied in a dependency graph, sometimes implemented as a dependency tree. Some embodiments may flatten the dependency graph when automatically applying 1248 updates. For example, assume a developer decides to use a third party package, which in this example is named Contoso.MagicWebServer. Suppose this package depends in turn on some part of asp.net™ (mark of Microsoft Corporation), say Microsoft.AspNetCore.Foo (a hypothetical example). Suppose Foo has a security bug, and in removing the bug the Foo version has changed from 1.0 to 1.1, but the publisher Contoso hasn't updated their package Contoso.MagicWebServer, and the developer wants the Foo fix included in their next build. Then in this example the developer may add a direct reference in their project to the updated Foo version, which will override the dependency 1108 of Contoso.MagicWebServer on an older version of Foo. Instead of a transitive or indirect assembly to Foo, which brought Foo into the build via MagicWebServer, the dependency graph now has a direct dependency. This is an example of “flattening the dependency graph”, which may complicate a project somewhat. Automation could help, so when a tool 602, for instance, sees that Contoso.MagicWebServer has finally been updated, it could determine that the direct reference to Foo was added because of a component update, and trim the dependency graph accordingly to remove unused or inconsistent links.

Some Observations About Vulnerability, Telemetry, and Privacy

Some aspects of the innovations described herein originated in consideration of runtime, development and build time detection of .NET Core™ and ASP.NET Core™ (marks of Microsoft Corporation) security updates. Although Microsoft platforms and products are used as examples in this discussion, they are merely examples, in that the teachings presented are not limited to Microsoft platforms and products.

DevDiv had little or no visibility into customers running .NET or .NET Core applications 124 within Azure® PAAS (mark of Microsoft Corporation), or on-premise machines. Customer feedback about .NET Core telemetry indicated that customers wanted some clear benefit in exchange for disclosing detailed information about their platform configurations or operations. Customers also expressed they lacked a clear way to inventory applications running on servers. There was also some customer confusion around how to update .NET Core™ ASP.NET Core™ and ASP.NET MVC™ software (marks of Microsoft Corporation). Some network administrators had no inventory of where .NET Core™ applications were running, which makes manual updating of the CLI problematic. There was little or no visibility of platform, framework, and component use in cloud services, containers, or other cloud systems. This situation presented challenges and an opportunity to provide customers with clear added value in return for limited telemetry data on what components their .NET applications are using.

Some embodiments enhance .NET Core™ or .NET Framework™ (marks of Microsoft Corporation) by adding runtime logging of an application's framework version 306, and of versions 306 of the NuGet packages it uses, to the local event log, or Linux® equivalent, which they can then query using whatever tools they normally use for event parsing. This runtime logging is coupled with runtime monitoring, where the runtime will pull a list 220 of known vulnerable runtimes and packages and warn 1206 customers that their applications need updating. Customers running within Azure® PAAS may be encouraged to install an agent that hooks into the runtime logging 214 and sends the same information to a storage account that Azure® Portal can use with the security logging in their application runtime and dependencies and give DevDiv information on the number of .NET™ and .NET Core™ applications running within PAAS VMs (marks of Microsoft Corporation). The same extension point may be used to expose .NET™ and .NET Core™ applications running within a hosting platform for web apps (e.g., one codenamed “Antares” by Microsoft), again with a portal extension to warn customers that their applications would benefit from updating and urging action to authorize or perform updates. A similar opt-in mechanism could be extended to Service Bus, Containers, and IoT hosts.

Tools and techniques employing a known vulnerability list 220 may help developers and promote improvements in computing systems by flagging vulnerable projects and packages during development and build, as well as by offering a guided update path which will reduce the risk of mistakes whilst following security bulletin instructions. Such an automated update mechanism could also become a runtime service for Windows®, Linux®, and MacOS® environments, to provide a multi-kernel automated update mechanism. One of skill will acknowledge that the Microsoft Update™ service does not cover Linux® or MacOS® environments.

Some embodiments address or solve both challenges using, e.g., a combination of security telemetry within the runtime, centralized logging to an OS appropriate logger and machine-readable documents served by a telemetry enabled service which contain details of vulnerable components, coupled with reporting on service usage and a command line option to update both the runtime and packages or other components. Supported Linux®, Windows® and other platforms gain an update service that can securely update the runtime automatically, and optionally also or alternately update packages.

A previously offered update process, e.g., for ASP.NET™ code, may be complicated and error prone, e.g., by reason of acts such as checking direct and indirect dependencies and then manually updating dependency version numbers. Some people who attempt to follow the process made errors, or omitted updates, thereby not obtaining the full available benefit of an available updated component. But some embodiments taught herein provide notifications 226 within a tool 602 when one adds a package with a security vulnerability. Some provide notifications 226 when a system 202 loads a solution 124 with vulnerable packages, or when the runtime version targeted contains a vulnerability 224. Some provide notifications when building 1250 a solution with vulnerabilities. In some, vulnerabilities flagged are raised as compilation errors, so users can decide to flag these warnings as errors on build servers and fail the build.

Some embodiments support marking NuGet™ packages as “insecure”, providing fixed package version information 306, with metadata 304 such as a short description of the bug, a link to the vulnerability details (e.g., to a GitHub® issue), and an optional CVE (Common Vulnerabilities and Exposures) link. Links are https or otherwise secured in this example. In some embodiments, multiple packages 204 can be flagged and mapped against a single update 1010, and multiple vulnerabilities' information 302 can be detailed against an update. In some embodiments, NuGet or a similar tool 122 provides additional fields for packages and the ability to flag 238 packages, and then parses the flagged packages to produce the vulnerability feed 232, 220. In some embodiments, the feed 232 will contain one or more timestamps for the last update time. In some embodiments, this is coordinated with staged updates. In contrast with an approach that updates ASP.NET™ packages on a NuGet-style site on a package by package basis, uploading vulnerability descriptions 302 in bulk and then marking 238 an entire set of replacement packages as released updates would reduce or solve the challenge that on Patch Tuesday a security bulletin may precede the full availability of the fixed dependency graph.

Although some examples herein discuss a single feed 232, one of skill will recognize that multiple feeds 232, and indeed multiple vulnerabilities bases 216, may be used by some embodiments or be part of some embodiments. For example, CLI runtimes and SDKs may be delivered from Azure® Table Storage, instead of joining packages 902 delivered from NuGet. Deliveries from two or more list 220 sources (feeds, websites, repositories, a specified URI, etc.) may be coordinated. Feeds 232 and other lists 220 may be digitally signed by a recognized authority, e.g., a vendor or trusted service provider, and authentication may be part of obtaining 1002 the vulnerabilities list(s) 220. In some embodiments, feed 232 retrieval will send no information from the retrieving machines 202; it will simply be a GET request to the HTTPS endpoint.

In some embodiments, tooling 122, 602, 612, 614, 616 and runtimes 120, 604, 620 will check the vulnerability feeds at least once every 24 hours and cache copies locally. Tooling updates may include a feed or other list 220 that was accurate at their time of publication, to support offline checking for vulnerabilities. This static list would be superseded by any list 220 retrieved online which has a later publication date. Build 1250 servers may have an optional build step which ensures the feed or other list 220 is up to date before a build starts. A tool may ensure that the vulnerability list 220 it references is up to date on loading the tool, and continue to background refresh the list every K hours (K being configurable). When a solution 124 is loaded, or a package reference is added, a development tool may parse the solution or package information and compare it against the current vulnerability list. If a vulnerability is discovered, either in the packages, or the currently targeted runtime, then the tool would log a warning in an error window, and ensure that the window is brought into focus to highlight the vulnerability for developers.

Some embodiments go beyond warnings by giving developers a convenient way to retarget a project against a non-vulnerable runtime, including downloading and installing it. This retargeting may also update both direct and indirect dependencies of packages to non-vulnerable versions. As to convenience, in some embodiments the retargeting may be initiated with a single click.

In some embodiments, during build the build process will compare the full dependency graph and targeting runtime to the current vulnerability list 220. If a vulnerability is discovered a build warning is logged. Developers can decide whether to “treat all warnings as errors” and halt builds.

In some embodiments, notifications are given during application startup 1256 when the application 124 depends on vulnerable components. In some embodiments, the runtime proactively performs a periodic vulnerability check on each application it is hosting (or only on selected applications), e.g., every 24 hours. If the runtime itself or any packages or other components are known to contain vulnerabilities, then an event is logged 214 to the host OS logging system. This checking and logging functionality may be extensible via a provider model. In addition, a similar mechanism may be exposed via a shell or runtime or framework command, for both checks and automatic upgrading.

Some embodiments provide or use a Windows® service and a Linux® daemon for pulling down and installing updates, for both the runtime and a local package cache (e.g., GAC light). The runtime registers itself when an application starts, to allow the automatic restart of applications rather than a full reboot of systems. A rollback mechanism is also present to back out of updates.

In some embodiments, an Azure® portal reads notifications from the runtime logging done by the OS logging mechanism, and warns users that their applications should be updated. Azure® or other portals may have an “Update” button to perform the same automatic updating that tooling such as Visual Studio® tooling can provide.

In some embodiments, the runtime checks provide an opportunity to gather intelligence on the number of .NET Core applications within a cloud environment, assuming the hosting processes can react to system logged events. When Azure® software or other cloud software can react to OS logging events, one can determine how many vulnerable applications are running within the pertinent cloud. The runtime could also log checks which do not result in discovery of vulnerable packages, giving a better picture of how many .NET Core™ applications the cloud is hosting. Also, there may be a lag time between runtime updates and their deployment throughout a cloud. Logging runtime vulnerabilities based on version number will help document and prioritize the lag time.

The same or similar runtime checks may be integrated into the .NET Framework™ or another framework, which would provide both visibility and update notifications for software shipped, e.g., NuGet™ packages such as MVC. Automatic update mechanisms through Visual Studio® and other development tools could be supported in the same way as Core package updates would be supported. A command line facility may be created for package updates. Framework updates may still be pushed through Microsoft Update or other existing mechanisms.

Feed Format

One of skill will appreciate that various list 220 formats and various delivery mechanisms may be used in obtaining 1002 a vulnerability list 220. Accordingly, the following example feed 232 formats are provided as illustrations, not as requirements.

Vulnerable Package Feed

The following format may be used in implementing a vulnerability feed 232 which serves a list 220 of vulnerable component 218 descriptions, in the form of vulnerable package 902, 218 descriptions. A given implementation may use different terms, and may include a scoring mechanism so developers can prioritize updates. One suitable scoring mechanism combines weighted factors such as exploit type and risk of exploitation. The actual data values shown here are mock values; the values are provided here to help illustrate the format:

```
{
  ″lastUpdated″:″2017-08-01T20:12:00.000Z″,
  ″vulnerablePackages″:[
  {
    ″packageID″:″Microsoft.Example.Package″,
    ″vulnerableVersions″:[″1.0.0″],
    ″fixedVersion″:″1.0.1″,
    ″releaseDate″:″2017-02-01T20:12:15.654Z″,
    ″vulnerabilityInformation″: [
    {
      ″vulnerability″:″EoP″,
      ″detailsLink″:″https://example.com/issues/1″,
      ″cveIssue″:12345
    },
    {
      ″vulnerability″:″XSS″,
      ″detailsLink″:″https://example.com/issues/2″,
      ″cveIssue″:12345
    }]
  },
  {
    ″packageID″:″Microsoft.Example.Package2″,
    ″vulnerableVersions″:[″1.0.0″,″1.0.1″,″1.0.2″],
    ″fixedVersion″:″1.0.4″,
    ″releaseDate″:″2017-02-01T20:12:15.654Z″
  }]
}
```

Runtime Feed

The following format may be used in implementing a vulnerability feed 232 which serves a list 220 of vulnerable SDK 608 and other runtime 604 component 218 descriptions. The actual data values shown here are mock values; the values are provided here to help illustrate the format:

```
{
  ″lastUpdated″:″2017-08-01T20:12:00.000Z″,
  ″vulnerableRuntimes″:[
  {
    ″Platforms″:[″win32″,″win64″],
    ″vulnerableVersions″:[″1.0.0″],
    ″fixedVersion″:″1.0.1″,
    ″releaseDate″:″2017-02-01T20:12:15.654Z″,
    ″vulnerabilityInformation″: [
    {
      ″vulnerability″:″EoP″,
      ″detailsLink″:″https://example.com/issues/1″,
      ″cveIssue″:12345
    },
    {
      ″vulnerability″:″XSS″,
      ″detailsLink″:″https://example.com/issues/2″,
      ″cveIssue″:12345
    }]
  }],
  ″vulnerableSDKs″:[
  {
    ″Platforms″:[″win32″,″win64″],
    ″vulnerableVersions″:[″1.0.0″],
    ″fixedVersion″:″1.0.1″,
    ″releaseDate″:″2017-02-01T20:12:15.654Z″,
    ″vulnerabilityInformation″: [
    {
      ″vulnerability″:″EoP″,
      ″detailsLink″:″https://example.com/issues/1″,
      ″cveIssue″:12345
    },
    {
      ″vulnerability″:″XSS″,
      ″detailsLink″:″https://example.com/issues/2″,
      ″cveIssue″:12345
    }]
  }]
}
```

Some Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants describe above.

Conclusion

In short, with the benefit of teachings provided herein, an embodiment may be used to protect 1018 private configuration information 212, 502 and private operation information 244, 502, while obtaining 1002 pertinent data 220 about known vulnerabilities of packages 902, runtimes 604, and software components 204 of various kinds. Dependencies 1108 between software items may be traversed 1252 to get more complete vulnerability information. Version numbers 306 and other telemetry about installed components 210, and operational events 244 from installed components, may be exported 1216 from a system 202 while nonetheless protecting the privacy of system-specific details such as the list 212 of components that are installed on, archived on, or otherwise utilizable on the system 202. Privacy protections 1020 may include withholding 1222 private information from a repository or other vulnerability list source 216, using 1016 truncated hashes or fingerprints 506 to select an obscuring subset 504 of the available vulnerability list, anonymizing 1254 telemetry, aggregating 1218 telemetry, deleting copies of a requester's ID 502 outside the requester 202, and other mechanisms. Vulnerability warnings 226 may be given 1206 upon loading 1232 a component or launching 1256 an application 124, building 1250 a project 610, selecting 1236 a component 204 for deployment 1238, adding 1230 a component to a project 610 or workspace 1106, and other events 1102. Updates 1010 to components may be performed to remove known vulnerabilities 224.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 10 and 12 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific APIs, specific fields, specific kinds of components, and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured for private proactive vulnerability detection and notification, the computing system comprising:
a processor;
a memory in operable communication with the processor;
a component utilizer;
a vulnerability detection and notification provider, which upon execution by the processor performs at least the following: (a) obtains a vulnerable components list which includes multiple vulnerable component descriptions, each vulnerable component description including vulnerable component metadata which identifies a particular version of a vulnerable component and also including vulnerability metadata which denotes a particular security vulnerability of the identified particular version of the vulnerable component, (b) compares at least a portion of the vulnerable components list to a utilizable components list, the utilizable components list including multiple utilizable component descriptions, each utilizable component description including utilizable component metadata which identifies a particular version of a utilizable component which is installed on the computing system or is otherwise available to the component utilizer for utilization on the computing system, and (c) generates a vulnerability notification that is formatted to notify a user of the computing system that at least one utilizable component is also a vulnerable component; and
wherein the vulnerable components list includes at least one component that is not also a utilizable component.

2. The computing system of claim 1, wherein the component utilizer includes at least one of the following: a kernel, a runtime, an extensible development tool, a deployment tool, a project building tool, a software development kit, or an integrated development environment.

3. The computing system of claim 1, wherein at least one of the following is satisfied:
the component utilizer operates in an infrastructure-as-a-service environment and the vulnerable components list identifies at least one infrastructure component;
the component utilizer operates in a platform-as-a-service environment and the vulnerable components list identifies at least one kernel component; or
the component utilizer operates in a software-as-a-service environment and the vulnerable components list identifies at least one application component.

4. The computing system of claim 1, wherein the vulnerability notification includes at least one of the following: an operating system log, a syslog mechanism log, or a log in a format compatible with a security information and event management tool.

5. The computing system of claim 1, further comprising a components updater which updates one or more utilizable vulnerable components, thereby removing at least one vulnerability from the computing system.

6. The computing system of claim 1, further comprising a components telemetry exporter which upon execution by the processor exports from the computing system at least a portion of the utilizable components list.

7. The computing system of claim 1, wherein the utilizable component metadata includes at least three of the following kinds of component metadata: a package publisher, a package version, a package publisher signature, a package hash value, a package contents manifest identifying assemblies of the package, an assembly version, or a hash value of one or more assemblies.

8. A method for private proactive vulnerability detection and notification, the method comprising:
proactively obtaining, from a vulnerable components list source, a vulnerable components list which includes multiple vulnerable component descriptions, each vulnerable component description including vulnerable component metadata which identifies a particular version of a vulnerable component and also including vulnerability metadata which denotes a particular security vulnerability of the identified particular version of the vulnerable component;
proactively getting a utilizable components list which includes multiple utilizable component descriptions, each utilizable component description including utilizable component metadata which identifies a particular version of a utilizable component which is installed on a particular computing system or is otherwise available for utilization on the particular computing system;
proactively avoiding supplying to the vulnerable components list source any information which specifically identifies any of the listed utilizable components, thereby withholding from the vulnerable components list source identification of the computing system's installed components;
comparing at least a portion of the vulnerable components list to at least a portion of the utilizable components list, thereby ascertaining one or more utilizable vulnerable components, namely, one or more components which are on both the vulnerable components list and the utilizable components list; and
generating a vulnerability notification that names at least one utilizable vulnerable component.

9. The method of claim 8, further comprising placing at least one date constraint which limits content of the vulnerable components list.

10. The method of claim 8, further comprising the vulnerable components list source avoiding maintaining any record which indicates that a particular component is one of the utilizable components of the particular computing system.

11. The method of claim 8, wherein obtaining the vulnerable components list comprises sending the vulnerable components list source a component set selector which specifies a component set having a plurality of components which includes at least one of the particular computing system's utilizable components, without specifying any particular individual utilizable component.

12. The method of claim 8, wherein the comparing or the generating or both are performed in response to one or more of the following events:
a utilizable component is added to a development project;
a utilizable component is added to a development workspace;
a utilizable component is loaded for execution;
a utilizable component is included during an executable build operation; or
a utilizable component is selected for deployment.

13. The method of claim 8, further comprising exporting from the particular computing system at least a portion of the utilizable components list.

14. The method of claim 8, wherein the method comprises a runtime proactively obtaining the vulnerable components list, the runtime ascertaining one or more utilizable vulnerable components, and the runtime generating the vulnerability notification.

15. The method of claim 8, wherein the method comprises avoiding exporting any of the utilizable component metadata to the vulnerable components list source.

16. The method of claim 8, wherein the method comprises providing component metadata of utilizable vulnerable components to a cloud-based security service.

17. A storage medium configured with code which upon execution by one or more processors performs a vulnerability notification method, the method comprising:
receiving over a network connection a request from a component utilizing system for a vulnerable components list; and
sending a vulnerable components list toward the component utilizing system, the vulnerable components list including multiple vulnerable component descriptions, each vulnerable component description including vulnerable component metadata which identifies a particular version of a vulnerable component and also including vulnerability metadata which denotes a particular security vulnerability of the identified particular version of the vulnerable component;
wherein the method is further characterized by each of the following privacy protections:
the request is free of any representation that a particular utilizable component is installed on the component utilizing system;
the request is free of any representation that a particular utilizable component is included in a build on the component utilizing system;
the request is free of any representation that a particular utilizable component is part of a development project on the component utilizing system;
the request is free of any representation that a particular utilizable component is part of a development workspace on the component utilizing system;
the request is free of any representation that a particular utilizable component is loaded for execution on the component utilizing system; and
the request is free of any representation that a particular utilizable component is selected for deployment on the component utilizing system, or selected for deployment from the component utilizing system, or selected for deployment controlled by the component utilizing system.

18. The storage medium of claim 17, wherein the receiving comprises receiving a request containing a component set selector, the method further comprises selecting a component set based on the component set selector, the selected component set being a proper subset of a set of vulnerable components, and wherein the sending comprises sending vulnerable component descriptions which correspond to components of the selected component set.

19. The storage medium of claim 17, wherein the receiving comprises receiving a request containing at least one of: a date constraint, a kernel constraint, wherein the method further comprises selecting vulnerable component descriptions based on the one or more request constraints, and the sending comprises sending the selected vulnerable component descriptions and avoiding sending vulnerable component descriptions which do not meet the one or more request constraints.

20. The storage medium of claim 17, wherein the method further comprises adding or changing a vulnerable component description in response to an authorized vulnerability update command.
